(19) United States
(12) Patent Application Publication
(10) Pub. No.: US 2024/0094833 A1
(43) Pub. Date: Mar. 21, 2024

(54) TRAJECTORY INPUT SYSTEM

(71) Applicants: Kabushiki Kaisha Toshiba, Tokyo (JP); Toshiba Electronic Devices & Storage Corporation, Tokyo (JP)

(72) Inventors: Junichi TAKEDA, Yokohama Kanagawa (JP); Koji RYUGO, Yokohama Kanagawa (JP)

(21) Appl. No.: 18/102,023

(22) Filed: Jan. 26, 2023

(30) Foreign Application Priority Data
Sep. 16, 2022 (JP) 2022-148442

(51) Int. Cl. G06F 3/0354; G06F 3/01; G06F 3/041

(52) U.S. Cl. CPC G06F 3/03545; G06F 3/011; G06F 3/04162

(57) ABSTRACT

A trajectory input system of an embodiment includes a plurality of pen-shaped terminals that respectively store unique ID data; and a display configured to receive trajectory data inputted by one of the plurality of pen-shaped terminals that contacts a surface of the display, in which the pen-shaped terminal detects input of the trajectory data to the display while the pen-shaped terminal is in proximity to the surface of the display and is within 10 mm from the surface of the display or while the pen-shaped terminal is in contact with the surface of the display, and transmits the unique ID data to the display, and the display manages the trajectory data by linking the unique ID to the trajectory data.

### CROSS-REFERENCE TO RELATED APPLICATION

This application is based upon and claims the benefit of priority from the prior Japanese Patent Application No. 2022-148442 filed on Sep. 16, 2022; the entire contents of which are incorporated herein by reference.

### FIELD

An embodiment of the present invention relates generally to a trajectory input system for inputting trajectory data to a display using a pen-shaped terminal.

### BACKGROUND

A trajectory input system, such as an electronic notebook or an electronic blackboard, that inputs writing to a display using a pen-shaped terminal (hereinafter referred to as an “electronic pen”) has been in widespread use. In the trajectory input system, when contact of the electronic pen with the display is detected, a movement trajectory of the electronic pen is displayed as an image on the display, and also, the trajectory data is stored in a memory.

Meanwhile, in a trajectory input system that manages trajectory data of a plurality of electronic pens, which are respectively assigned unique ID data, based on the respective unique IDs, it is possible to delete only a trajectory of an electronic pen with a given unique ID, or display a trajectory of an electronic pen with a given unique ID in a color different from colors of trajectories of the other electronic pens on a display.

### BRIEF DESCRIPTION OF THE DRAWINGS

FIG. 1 is a perspective view of a trajectory input system of an embodiment;

FIG. 2 is a configuration diagram of the trajectory input system of the embodiment;

FIG. 3 is a flowchart of an operation method of the trajectory input system of the embodiment;

FIG. 4A is trajectory data for illustrating the operation method of the trajectory input system of the embodiment;

FIG. 4B is trajectory data for illustrating the operation method of the trajectory input system of the embodiment; and

FIG. 5 is a configuration diagram of a trajectory input system of a modification of the embodiment.

### DETAILED DESCRIPTION

A trajectory input system of the present embodiment is a trajectory input system including a plurality of pen-shaped terminals that respectively store unique ID data; and a display configured to receive trajectory data inputted by one of the plurality of pen-shaped terminals that contacts a surface of the display, in which the pen-shaped terminal detects input of the trajectory data to the display while the pen-shaped terminal is in proximity to the surface of the display and is within 10 mm from the surface of the display or while the pen-shaped terminal is in contact with the surface of the display, and transmits the unique ID data to the display, and the display manages the trajectory data by linking the unique ID to the trajectory data.

### Embodiment

Hereinafter, a trajectory input system of an embodiment will be described in detail with reference to the drawings.

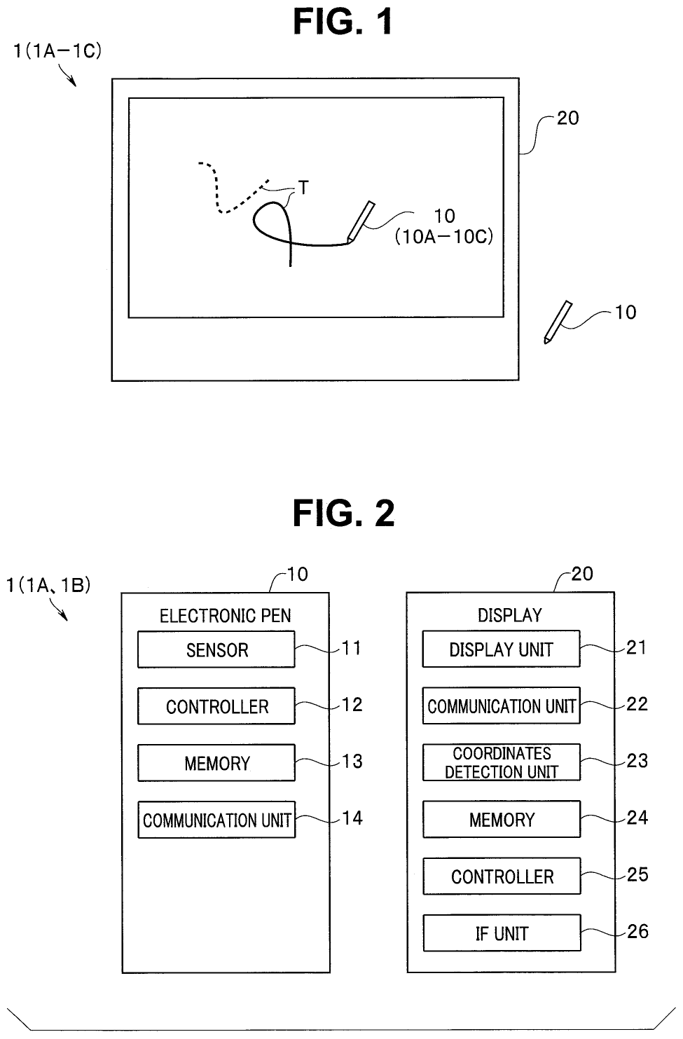

As illustrated in FIGS. 1 and 2, a trajectory input system 1 of the embodiment includes electronic pens 10A and 10B, which are pen-shaped terminals, and a display 20. Hereinafter, each of the electronic pens 10A and 10B will be referred to as an electronic pen 10.

The electronic pen 10 includes a sensor 11, a controller 12, a memory 13, and a communication unit 14.

The sensor 11 is a pressure sensor, such as a piezoelectric element, and detects contact of a distal end of the electronic pen 10 with a surface of the display 20. The controller 12 is a CPU or the like configured to control the overall operation of the electronic pen 10. The memory 13 stores unique ID data. The communication unit 14 wirelessly transmits the unique ID data to the display 20 when the sensor 11 detects contact.

The display 20 includes a display unit 21, a communication unit 22, a coordinates detection unit 23, a memory 24, a controller 25, and an IF unit 26.

The display unit 21 that displays a trajectory T is a liquid crystal display panel, for example. The display unit 21 may be a projector projection-type display unit. When the electronic pen 10 is an ink pen, the display unit 21 may be a whiteboard. The communication unit 22 receives data transmitted from the electronic pen 10.

The coordinates detection unit 23 detects a position of the surface of the display unit 21 contacted by the distal end of the electronic pen 10. The coordinates detection unit 23 continuously detects contact positions of the electronic pen 10 to detect trajectory data drawn on the display unit 21. The coordinates detection unit 23 is a digital pressure-sensitive coordinates detection unit configured to detect a change in a gap between two sheets pressed by the electronic pen 10, for example. The digital pressure-sensitive coordinates detection unit 23 acquires the coordinates of the pressed portion based on a change in the resistance value or capacitance.

The coordinates detection unit 23 may also be an electromagnetic or laser-based coordinates detection unit. The electromagnetic coordinates detection unit includes a plurality of wires in the X-axis direction and a plurality of wires in the Y-axis direction that are embedded immediately below the display unit 21, and detects the position of the electronic pen 10 based on electromagnetic induction with a coil of the electronic pen 10. The laser-based coordinates detection unit detects the position of the electronic pen 10 when a laser beam, which scans the surface of the display unit 21 in a direction parallel with the surface, is reflected by a reflecting plate of the electronic pen 10.

The memory 24 stores the unique ID of each electronic pen 10 in advance. The memory 24 also stores the inputted trajectory data. The controller 25 is a CPU or the like configured to control the overall operation of the display 20. The IF unit 26 is connected to an external computer or a communication line, and can transfer trajectory data, for example.

Once the coordinates detection unit 23 starts to detect contact of the electronic pen 10, the controller 25 of the display 20 determines that a trajectory of the electronic pen 10 is being inputted, and manages the trajectory data by linking the unique ID of the electronic pen 10 received by the communication unit 22 to the trajectory data.

In such a trajectory input system including a plurality of electronic pens, there may be a case where while a display is detecting input of trajectory data of a first electronic pen, a second electronic pen that is not used for inputting a trajectory transmits a unique ID. In such a case, the display may erroneously link the unique ID of the second electronic pen to the trajectory data of the first electronic pen that is being inputted. Further, if an electronic pen not in use transmits a unique ID, power is consumed. Thus, the long-hour use of battery-driven electronic pens has not been easy.

In the trajectory input system 1, the timing of detecting contact and the timing of receiving a unique ID are preferably almost concurrent or have a difference of less than or equal to 1 second, for example, so that the unique ID of the electronic pen 10A in use and the unique ID of the electronic pen 10B not in use are distinguished from each other without confusion. The time difference between the timing of detecting contact and the timing of receiving a unique ID is an attribute linked to the electronic pen 10, and is particularly preferably less than or equal to a time period in which a user is able to draw a trajectory without an odd feeling, for example, less than or equal to 30 milliseconds.

<Operation Method of Trajectory Input System>

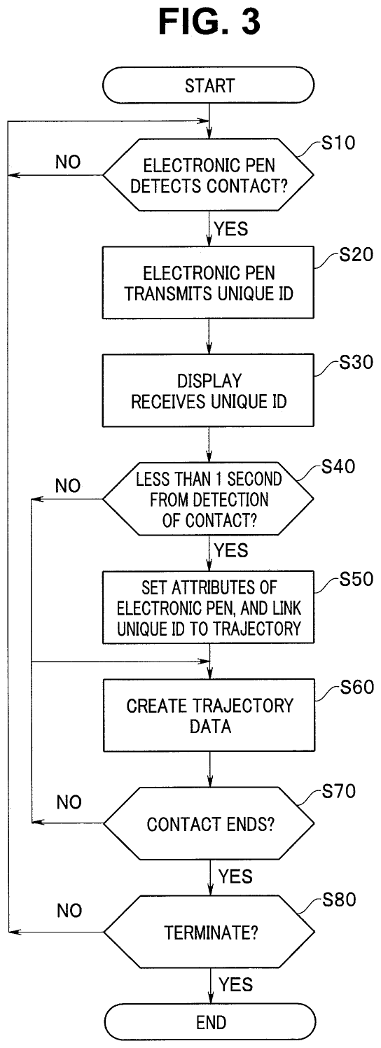

An operation method of the trajectory input system 1 will be described with reference to a flowchart of FIG. 3.

<Step S10>

A user holds one of the plurality of electronic pens 10 (for example, the first electronic pen 10A), and places the pen tip (the distal end) of the electronic pen 10 on the surface of the display unit 21. Then, the sensor 11 of the electronic pen 10 detects that the electronic pen 10 is in contact with the display 20.

<Step S20>

The communication unit 14 of the electronic pen 10 transmits the unique ID to the display 20.

<Step S30>

The communication unit 22 of the display 20 receives the unique ID from the electronic pen 10.

<Step S40>

If the unique ID is received from the electronic pen 10 immediately after the coordinates detection unit 23 of the display 20 has detected the contact of the electronic pen 10, for example, within 1 second (YES), the flow proceeds to step S50.

<Step S50>

The controller 25 of the display 20 reads the attributes (e.g., the pen thickness, color, line type, and layer) of the electronic pen 10 corresponding to the unique ID of the electronic pen 10 stored in the memory 24 in advance, and sets the attributes, and also links the unique ID of the electronic pen 10 to the trajectory data. Note that the attributes may be stored in the memory 13 of the electronic pen 10 so that the attributes are transmitted to the display 20 together with the unique ID.

Note that if the answer to step S40 is “NO,” the flow proceeds to step S60 so that the default attributes or the attributes immediately before of the electronic pen 10 are used, for example.

<Step S60>

When the distal end of the electronic pen 10 moves while being in contact with the surface of the display 20, trajectory data is created by the coordinates detection unit 23. The trajectory is displayed on the display unit 21 based on the attributes of the electronic pen 10, and is also stored as the trajectory data in the memory 24 concurrently.

<Step S70>

The creation of the trajectory data in step S60 continues until the distal end of the electronic pen 10 is moved away from the surface of the display 20 (YES in S70).

The electronic pen 10 preferably transmits the unique ID data only when the electronic pen 10 has detected the start of input of trajectory data, but the electronic pen 10 may transmit the unique ID again after the end of the contact (YES in S70) for double-check purposes. In other words, the electronic pen 10 may transmit the unique ID data only when the electronic pen 10 has detected the start of input of trajectory data and when the electronic pen 10 has detected the end of the input of the trajectory data.

Note that when the trajectory input system is the one in which battery consumption of the electronic pen 10 is not a big issue, for example, the electronic pen 10 may repeatedly transmit the unique ID while the trajectory data is created (S60).

<Step S80>

The process from step S10 is repeated until the use of the trajectory input system 1 terminates (YES in S80).

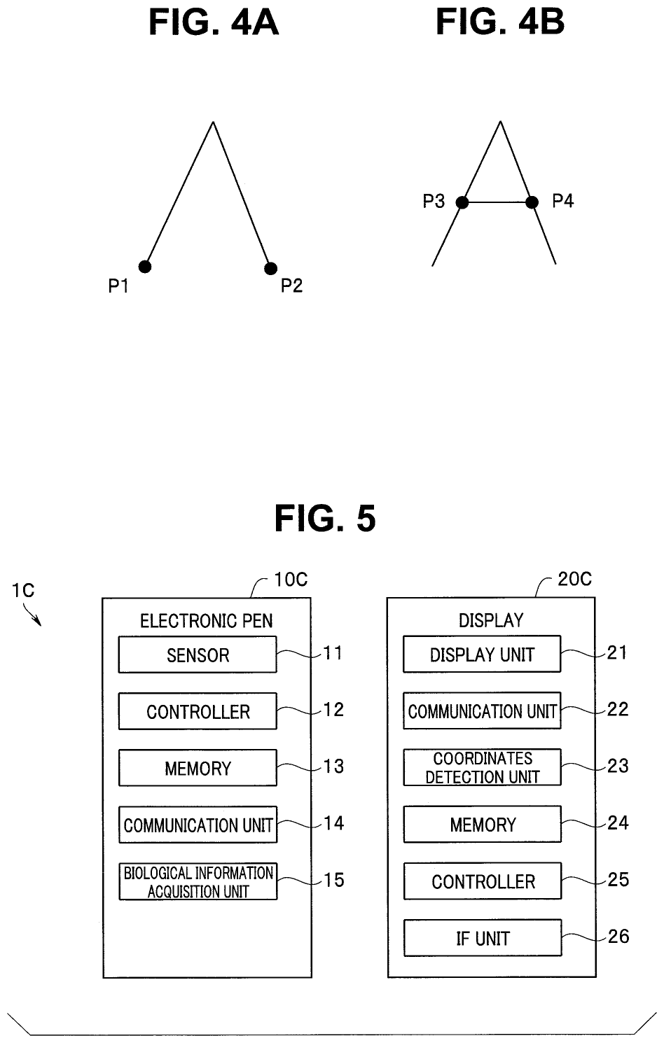

FIGS. 4A and 4B illustrate a case where a letter “A” is written as a figure on the display 20 using the electronic pen 10. As illustrated in FIG. 4A, when the distal end of the electronic pen 10 contacts the position of a point P1 on the display 20 (YES in S10 in FIG. 3), the electronic pen 10 transmits the unique ID to the display 20 (S30 in FIG. 3). When the distal end of the electronic pen 10 moves to the position of a point P2 while being in contact with the display 20, a trajectory is drawn on the display unit 21 based on the attributes linked to the unique ID of the electronic pen 10, and also, the trajectory data is stored in the memory 24 of the display 20 (S60 in FIG. 3). The electronic pen 10 is moved away from the display 20 at the position of the point P2 (YES in S70 in FIG. 3). In other words, the contact between the electronic pen 10 and the display 20, which has continued from the position of the point P1, ends at the position of the point P2.

As illustrated in FIG. 4B, the electronic pen 10 contacts the position of a point P3 on the display 20. The electronic pen 10 transmits the unique ID so that a trajectory is drawn up to the position of a point P4 based on the attributes linked to the unique ID of the electronic pen 10, and also, the trajectory data is stored in the memory 24 of the display 20.

Note that the trajectory data is managed together with the attributes. Therefore, a trajectory TA drawn by the electronic pen 10A and a trajectory TB drawn by the electronic pen 10B can be managed independently. For example, on the display unit 21 of the display 20 where the trajectory TA and the trajectory TB are displayed in a superposed manner, only the trajectory TB can be hidden. It is also possible to easily change only the attributes (e.g., the thickness, color, line type, and layer) of the trajectory TA after the trajectory TA is drawn.

In the trajectory input system 1, when the first electronic pen 10A detects contact of the first electronic pen 10A with the display 20, the first electronic pen 10A transmits the unique ID to the display 20. The second electronic pen 10B, which does not detect contact of the second electronic pen 10B with the display 20, does not transmit the unique ID.

In the trajectory input system 1 including the plurality of electronic pens 10A and 10B, the unique ID of the electronic pen 10A is not linked to the trajectory data of the electronic pen 10A unless the difference between a time point when the coordinates detection unit 23 of the display 20 starts to acquire the trajectory data of the electronic pen 10A in use and a time point when the communication unit 22 of the display 20 starts to receive the unique ID of the electronic pen 10A is within 1 second, for example. Therefore, the trajectory inputted by the electronic pen 10A can be reliably managed by being linked to the unique ID of the electronic pen 10A. Since each electronic pen 10 does not transmit the unique ID when not in contact with the display 20, power consumption can be suppressed. Thus, even when the electronic pen 10 is a battery-driven electronic pen, the long-hour use of the electronic pen is possible.

The unique ID of the electronic pen 10 may be changeable. It is also possible to set different unique IDs on a single electronic pen 10 by operating a switch of the electronic pen 10 by a user, for example. The trajectory input system 1 may include three or more electronic pens 10.

<Modifications>

Trajectory input systems 1A and 1B of modifications are similar to and have the same advantageous effects as the trajectory input system 1 of the embodiment. Thus, components with the same function are denoted by the same reference sign, and repeated description will be omitted.

<Modification 1>

In the trajectory input system 1A of the present modification, the coordinates detection unit 23 of the display 20 is a laser-based coordinates detection unit. The electronic pen 10 includes a photosensor as the sensor 11. The electronic pen 10 detects that the electronic pen 10 is in contact with or in proximity to the display 20 when the photosensor receives a laser beam that scans the surface of the display unit 21 in a direction parallel with the surface.

Note that the electronic pen 10 may detect that the electronic pen 10 is in contact with or in proximity to the display 20 based on light emitted from a light source different from the laser of the coordinates detection unit 23.

<Modification 2>

In the trajectory input system 1B of the present modification, the electronic pen 10 includes a coil as the sensor 11. The sensor 11 of the electronic pen 10 detects that the electronic pen 10 is in proximity to the display 20 based on a magnetic field from the display 20.

When a magnetic field generated by a coil of the display 20 is applied to the coil of the electronic pen 10, a current flows through the coil due to the electromagnetic induction effect. For example, in a communication system compliant with the NFC standards, when the coil of the electronic pen 10 is in proximity to the surface of the display 20, specifically, a position within 10 mm from the surface of the display 20, for example, a position of 2 mm, the amount of current that is sufficient to drive the electronic pen 10 flows through the coil of the electronic pen 10.

The electronic pen 10 detects that the electronic pen 10 is in proximity to the display 20 by receiving power, and transmits the unique ID to the display 20 with the received power.

When the electronic pen 10 and the display 20 are connected via near field communication that allows for communication over a relatively long distance, for example, about 10 m, it is possible to detect that the electronic pen 10 is in contact with the display 20 based on notification from the display 20.

For example, when the coordinates detection unit 23 starts to detect input of a trajectory, the display 20 checks all network IDs (e.g., IP addresses) received through near field communication, and the strengths of respective radio waves (RSSI). Then, the display 20 notifies an electronic pen with a network ID with the strongest RSSI of the fact that the coordinates detection unit 23 has started to detect input of a trajectory of the electronic pen. If such notification is addressed to the electronic pen 10, the notified electronic pen 10 transmits to the display 20 the unique ID different from the network ID.

As described above, the electronic pen 10 detects that the electronic pen 10 is in contact with or in proximity to the display 20, that is, detects the start of input of trajectory data using a pressure sensor, a photosensor, or a coil, and then transmits the unique ID.

Note that when the electronic pen 10 detects that the electronic pen 10 is in proximity to the display 20 and then transmits the unique ID as in Modification 1 or Modification 2, the display 20 detects that the electronic pen 10 is in contact with the display 20 after receiving the unique ID of the electronic pen 10. Either one of the detection of contact of the electronic pen 10 performed by the display 20 or the reception of the unique ID performed by the display 20 may precede the other. However, the detection timing and the reception timing are desirably almost concurrent or have a difference of less than or equal to 1 second, for example.

<Modification 3>

As illustrated in FIG. 5, in a trajectory input system 1C of the present modification, an electronic pen 10C includes a biological information detection unit 15 configured to detect biological information on a user holding the electronic pen 10C.

In the trajectory input system 1C, the biological information detection unit 15 is a fingerprint detection unit. Fingerprint data detected by the biological information detection unit 15 is stored and managed by being linked to trajectory data. In other words, the electronic pen 10C also transmits fingerprint data, which is biological information, when transmitting the unique ID data.

The fingerprint data, a name corresponding to the fingerprint data, and the like are stored in the memory 24 of a display 20C, or in a computer connected to the display 20C via the IF unit 26.

With the trajectory input system 1C, the name of a user who has drawn a trajectory T can be identified from the fingerprint data. In the trajectory input system 1C, the trajectory T is managed by being linked to the name of the user. In the trajectory input system 1C, a false signature of an unauthorized user can be invalidated, for example.

Note that the biological information acquired by the biological information detection unit 15 is not limited to information that identifies an individual. For example, the biological information may be the temperature of one's hand, one's pulse rate, the electric resistance of one's skin surface, or one's holding pressure. Trajectory data linked to the biological information can be used for various purposes.

For example, the trajectory input system 1C can determine the level of importance of the drawn trajectory data by grasping how nervous the user is from the pulse rate or electric resistance.

In the trajectory input system 1C, when the electronic pen 10C detects that the electronic pen 10C is in contact with or in proximity to the display 20C, the electronic pen 10C transmits biological information together with the unique ID. The trajectory data of the display 20C and the biological information of the electronic pen 10C are linked together only when the timing of detecting contact or proximity and the timing of receiving the unique ID are almost concurrent. The trajectory input system 1C has a higher security function than a trajectory input system in which the timing of transmitting biological information is not limited.

Note that the electronic pen 10C may transmit only the unique ID when detecting that the electronic pen 10C is in contact with or in proximity to the display 20C, and may transmit the biological information when detecting that the display 20C has received the unique ID immediately after detecting the contact.

In the trajectory input system 1C, the controller 12 of the electronic pen 10C may determine the start of input of trajectory data when the biological information detection unit 15 detects that the electronic pen 10C is being held by a user as a living organism and further when the sensor 11 detects that the electronic pen 10C is in proximity to or in contact with the display 20C. The electronic pen 10C that detects that the electronic pen 10C is being held by a user using the biological information can prevent erroneous transmission of the unique ID due to a malfunction of the sensor 11, for example.

Note that in the trajectory input system 1C including a plurality of electronic pens 10, at least one of the electronic pens 10 may include the biological information detection unit 15.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A trajectory input system comprising:
a plurality of pen-shaped terminals that respectively store unique ID data; and
a display configured to receive trajectory data inputted by a pen-shaped terminal of the plurality of pen-shaped terminals that contacts a surface of the display,
wherein:
each of the plurality of pen-shaped terminals detects input of the trajectory data to the display while the pen-shaped terminal is in proximity to the surface of the display and is within 10 mm from the surface of the display or while the pen-shaped terminal is in contact with the surface of the display, and transmits the unique ID data to the display,
the display manages the trajectory data by linking the unique ID to the trajectory data, and
a time difference between a timing at which the pen-shaped terminal of the plurality of pen-shaped terminals detects the input of the trajectory data and a timing at which the display receives the unique ID data is less than or equal to 30 milliseconds.

2. The trajectory input system according to claim 1, wherein the pen-shaped terminal of the plurality of pen-shaped terminals transmits the unique ID data only when the pen-shaped terminal detects a start of the input of the trajectory data.

3. The trajectory input system according to claim 1, wherein the pen-shaped terminal of the plurality of pen-shaped terminals transmits the unique ID data only when the pen-shaped terminal detects a start of the input of the trajectory data and when the pen-shaped terminal detects an end of the input of the trajectory data.

4. The trajectory input system according to claim 1, wherein the pen-shaped terminal of the plurality of pen-shaped terminals detects a start of the input of the trajectory data using a pressure sensor, a photosensor, or a coil.

5. The trajectory input system according to claim 1, wherein the pen-shaped terminal of the plurality of pen-shaped terminals receives a start of the input of the trajectory data from a notification sent from the display through wireless communication.

6. The trajectory input system according to claim 1,
wherein:
the pen-shaped terminal of the plurality of pen-shaped terminals includes a biological information acquisition unit, the biological information detector being configured to acquire biological information on a person holding the pen-shaped terminal, and
the pen-shaped terminal of the plurality of pen-shaped terminals also transmits the biological information when transmitting the unique ID data.

7. The trajectory input system according to claim 6,
wherein:
the biological information includes fingerprint data or a pulse rate, and
the trajectory data is stored by being linked to the fingerprint data or the pulse data.

8. The trajectory input system according to claim 6, wherein the pen-shaped terminal transmits of the plurality of pen-shaped terminals the unique ID data when the pen-shaped terminal acquires the biological information and detects a start of the input of the trajectory data.

9. The trajectory input system according to claim 6, wherein
the biological information includes data such as a temperature of a hand, a pulse rate, an electric resistance of a skin surface, or a holding pressure of a user, and
the data is stored by being linked to the trajectory data.
